(19) United States
(12) Patent Application Publication
(10) Pub. No.: US 2004/0040467 A1
(43) Pub. Date: Mar. 4, 2004

(54) Silicone based compositions

(76) Inventors: Raymond H. Thomas, Pendleton, NJ (US); Brian M. Naasz, Renton, WA (US); Guillermo J. Hitters, Hamburg, NJ (US); Gary M. Knopeck, Lakeview, NY (US)

Correspondence Address: Deborah Chess, Honeywell International Inc., 101 Columbia Road, Morristown, NJ, 07962-2245, US

(21) Appl. No.: 10/648,949

(22) Filed: Aug. 27, 2003

Related U.S. Application Data
(60) Provisional application No. 60/406,558, filed on Aug. 27, 2002.

(51) Int. Cl. C07G 1/00

(52) U.S. Cl. 106/287.1

(57) ABSTRACT

Silicone-based compositions and methods of forming silicone coatings comprising, as a carrier for the silicone compound(s), a composition comprising hydrocarbon molecules which contain from 2 to 10 carbon atoms and from about 50% to about 76% by weight, and in certain preferred embodiments from about 50% to about 70% by weight, of fluorine.

### CROSS-REFERENCE TO A RELATED APPLICATION

This application claims the benefit of prior filed U.S. Provisional Application No. 60/406,558, which was filed with the United States Patent and Trademark Office on Aug. 27, 2002 by the Express Mail procedure.

### FIELD OF THE INVENTION

The present invention provides silicone-based compositions and methods of forming silicone coatings comprising, as a carrier for the silicone compound(s), a composition comprising fluorinated hydrocarbon molecules.

### BACKGROUND

Silicones have found use in a wide variety of applications. For example, silicones are used in ink compositions, in cosmetics and other personal care products such as hair spray, in paints, in lubricants, in pharmaceuticals, in the manufacture of separation membranes, and in the manufacture of electronic components and other electronic equipment. In many of these applications, the silicone has to be coated onto a surface or otherwise uniformly applied in a relatively thin film. In such applications, it has been common practice to apply the silicone compound in the form of a solute in a solvent composition and to then remove the solvent, typically by evaporation, to leave the film or coating of silicone.

In order to ensure that the silicone compound is relatively evenly distributed in the coating or film, it is important that such compositions utilize a solvent that has a relatively low surface tension. This is because high surface tension materials would tend to bead up on the surface to be coated, thereby leaving portions of the surface uncoated. It is also desirable that the solvent have a relatively high evaporation rate to ensure that the coating or film can be formed in an economically feasible manner. If the evaporation rate of the solvent is too slow, the process for forming the coating or film will be slow, thus driving up the cost of forming the coating or film.

Prior to the present invention, it has been a conventional practice to employ nonpolar solvents such as xylene and/or polar solvents such as alcohols and glycol ethers as the solvents for silicone compositions. Although such compositions have achieved some success, many of the commonly used solvents are known to have adverse effects on the environment and/or worker safety. Furthermore, in recent years there has been an effort to reduce the use of volatile organic compounds (“VOCs”) and ozone depleting substances in view of their detrimental impact on the environment, their flammability and their hazards in the work place. There has also recently been a strong disadvantage in the use of chlorine containing compounds in such applications because of the damage that such compounds cause to the ozone layer of the atmosphere.

U.S. Pat. No. 5,352,378 teaches a nonflammable composition useful for applying a silicone lubricant to medical articles. The patent teaches that the compositions should include a silicone lubricant, a “fluorine-free” compound as the solvent for the silicone compound, and a highly fluorinated compound in an amount effective to impart a nonflammable characteristic to the composition. This patent specifically teaches that the solvent should have a boiling point that is higher than the boiling point of the highly fluorinated organic compound in order to ensure that the composition is not flammable. This composition suffers from many of the disadvantages described above. For example, the patent discloses that the preferred solvents include hydrocarbons (such as n-hexane, n-heptane, n-octane, and isooctane), ethers (such as isopropyl ether), and alcohols (such as isopropanol and t-butanol). These solvents are not only detrimentally flammable, they are all VOCs.

Furthermore, the '378 patent teaches that the component which is used to impart nonflammability to the composition may contain relatively high levels of chlorine, which as mentioned above is also detrimental to the ozone layer. In addition, the teachings of U.S. Pat. No. 5,352,378 indicate that many of the preferred highly-fluorinated compounds are perfluorinated. Such perfluorination is clearly desirable in the compositions of the '378 patent because its sole purpose is to impart nonflammable characteristics to the composition. Applicants have recognized, however, that the presence of perfluorinated compounds in the compositions of the '378 patent makes those compositions undesirable because they tend to impart a significant global warming potential to the compositions. More particularly, the perfluorinated compounds that are included in the '378 compositions have a Global Warming Potential (“GWP”) of from 8000 to 10000. Compositions containing substantial amounts of such high GWP compounds are undesirable from an environmental standpoint.

Therefore, applicants have recognized a need in the art to provide a silicone-based composition which is capable of relatively quickly forming a substantially uniform coating or film, which is environmentally friendly, and which is non-flammable.

### SUMMARY OF THE INVENTION

Applicants have discovered silicone-based compositions and methods of forming silicone coatings and films which satisfy many of needs and which overcome many of the disadvantages of the prior art. The composition aspect of the present invention involves the discovery that certain compounds are unexpectedly useful and surprisingly advantageous as carriers for silicone coating and film forming compounds. Generally, applicants have discovered that fluorinated hydrocarbon molecules which contain from 2 to 10 carbon atoms and from about 50% to about 76% by weight, and in certain preferred embodiments from about 50% to about 70% by weight, of fluorine can be used with great advantage as carriers in silicone based compositions. In general it is preferred that the hydrocarbon molecule is a hydrofluorocarbon (“HFC”), that is, a hydrocarbon which contains fluorine substituents but no chlorine substituents.

One facet the present invention derives from applicants' recognition that the specified hydrocarbons in general, and the specified HFCs in particular, can be effectively and advantageously used as carriers for silicones even if they are not solvents for such silicones. For embodiments in which the hydrocarbon compound is not a solvent for the silicone, applicants have found that these compounds can be used in combination with a surfactant to emulsify the silicone and thereby function effectively and advantageously as a carrier for the silicone. In such embodiments, the hydrocarbon, and preferably the HFC, is used in combination with one or more surfactant compounds to form a continuous phase of an emulsion in which the silicone or silicone precursor is the disperse phase.

Another facet of applicants' invention derives from the recognition that the preferred HFCs of applicants' invention are highly effective, non-flammable, chlorine-free solvents for many such silicones and silicone precursors.

### DETAILED DESCRIPTION OF PREFERRED EMBODIMENTS

The present invention provides a composition for forming a coating or film of silicone. In many applications the silicone will be formed as a coating on an article or substrate, but those skilled in the art will appreciate that the present compositions and methods will have utility in the formation of films or layers such as may be used in the formation of various silicone membranes. According to one preferred aspect of the present invention, the composition comprises a silicone coating or film forming agent, a carrier comprising a fluorinated hydrocarbon compound having from about 50% to about 76% by weight of fluorine and being capable of solvating or forming an emulsion with the silicone coating or film forming agent, and a surfactant in an amount sufficient to form an emulsion with any silicone coating or film forming agent which is not dissolved in the carrier.

Based on the overall teachings of the prior art, one would generally expect that only hydrocarbon compounds that are good solvents for silicone compounds could be used as effective carriers for silicone compounds. Prior to the present invention, therefore, those skilled in the art would be lead away from the use of the specified hydrocarbons, and the specified HFCs in particular, as carriers for such silicone compounds because of the belief that such compounds, especially HFCs with high concentrations of fluorine, are not solvents for silicone compounds. Contrary to the teachings of the prior art, applicants have unexpectedly discovered that the hydrofluorocarbons defined herein can be effective as carriers for silicone coating or film forming agents.

As used herein, the term “carrier” means a compound or combination of compounds that form part of the layer, film or coating from which a substantially uniform coating, film or layer of the silicone compound is formed. It is highly preferred that the carrier should have sufficient power to solvate and/or disperse (emulsify) the silicone material to be coated and to maintain a substantially uniform distribution of that amount of the material to be coated as the carrier is removed. The function of a “carrier” as used herein is therefore distinct from the function of a propellant, which serves to provide motive force to eject material from a container. It will be appreciated, however, that propellants may be used in certain embodiments of the present invention.

According to other preferred embodiments, the composition comprises a silicone coating or film forming agent, and a carrier comprising at least one fluorinated hydrocarbon compound which is a solvent for the silicone coating or film forming agent and which contains from about 2 to about 10 carbon atoms and from about 55 percent by weight and to about 76 percent by weight of fluorine. Based on the teachings of U.S. Pat. No. 5,352,378, one would expect that hydrocarbons having relatively high percentages of fluorine in the molecule are not effective or desirable as solvents for silicone compounds. Applicants have discovered that while many highly fluorinated hydrocarbons are either not effective or not desirable as solvents, that certain highly fluorinated C₂-C₆ hydrocarbon compounds are effective solvents for silicone compounds and precursors for silicone compounds. For the purposes of convenience, the term “C₂-C₆” is used herein to refer to hydrocarbons having 2 to 6 carbon atoms in the molecule, the term “C₃-C₅” is used to refer to hydrocarbons having 3 to 5 carbon atoms in the molecule, and so on. More particularly, applicants have discovered that certain C₂-C₆, and even more preferably C₃-C₅ hydrocarbons, having a fluorine content as specified herein are capable of effectively acting as solvents for a wide variety of silicone coating or film forming compounds. Although applicants do not intend to be bound by or to any particular theory of operation, it is believed that C₂-C₆ hydrocarbons having greater than about the herein specified weight of fluorine in the molecule are not particularly effective as solvents for silicone coating or film forming compounds and are undesirable because of their high GWP values and high cost. Conversely, such compounds having below about 50% by weight of fluorine tend to be undesirable from an environmental and flammability standpoint. According to preferred embodiments, the carrier of the present invention comprises at least one C₂-C₆ hydrocarbon, and preferably a C₂-C₆ HFC, which contains from about 55 percent by weight to about 76 percent by weight of fluorine, more preferably from about 60 percent by weight to about 76 percent by weight of fluorine, and even more preferably from about 65 percent by weight to about 76 percent by weight of fluorine.

The hydrocarbon compounds of the present invention preferably have a GWP of less than about 5000, more preferably less than about 2500, and even more preferably less than about 1500. In preferred embodiments, the hydrocarbon is an HFC with a GWP of less than about 1500, and even more preferably from about 500 to about 900. It is also generally preferred that the carrier of the present compositions does not contain more than about 60 percent by weight, and even more preferably not more than 50 percent by weight, of compound(s) with a GWP of greater than about 5000. In highly preferred embodiments, the carrier of the present compositions does not contain more than 40 percent by weight, and even more preferably not more than 30 percent by weight, of compound(s) with a GWP of greater than about 1000.

In general, those skilled in the art will appreciate that the silicone coating or film forming agent of the present invention will include one or more polysiloxane compounds, one or more polysiloxane precursors, or a combination of polysiloxane(s) and polysiloxane precursor(s). Additionally, copolymers comprising siloxane units are included as film forming agents. The copolymers can include siloxane and alkylene oxide units such as are found in SF-1188 and SF-1288 which are commercially available from GE Silicones. Other silicones that are useful include organofunctional fluids such as SF706, XS69-B5476, and silanols such as SF1023. Blends of various film forming agents are also included as being useful and effective. All such agents are contemplated to be adaptable for use within the broad scope of the present invention. Polysiloxane compounds are those polymeric compounds in which the polymer backbone includes repeating units based on —Si—O—, and all such polymeric units are believed to be adaptable for use in accordance with the present invention. As used herein, the term polysiloxane refers to all polymeric compounds which contain a substantial portion of —SiO— repeating units, including copolymers, terpolymers, etc. which other polymeric backbone structures. As used herein, the term “polysiloxane precursor” refers to those compounds, including monomers, oligomers and polymers, which can be cured or otherwise reacted to form a polysiloxane.

Although all polysilxanes and precursors are believed to adaptable for use with the present invention, in certain embodiments it is preferred that the polysiloxane or precursor comprise an organically modified polysiloxane. Preferably, the organically modified polysiloxane has the formula I below:

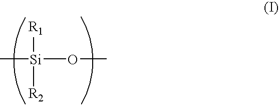

wherein R1 and R2 are the same or different, each independently representing an alkyl group, an aryl group, a group including a polyether unit, or a group including a polyester unit. In preferred embodiments of formula I, at least one of R₁ and R₂ is an alkyl group having 1 to 4 carbons, and even more preferably the alkyl group is methyl, ethyl or propyl.

Preferred polysiloxanes are polydialkylsiloxanes in which R₁ and R₂ are the same or different and are independently an alkyl group of from 1 to 20 carbon atoms. In preferred compounds of formula I, R₁ and R₂ are each methyl.

For formula I polysiloxanes, it is preferred that the number of repeating units, n, is sufficient to provide a viscosity of from about 1 to 1,000,000 centistokes at 25° C. (77° F.). In particularly preferred polydialkylsiloxanes of formula I, R₁ is methyl and the viscosity is from about 5 to about 100,000 centistokes 25° C. (77° F.). Examples of polydimethylsiloxanes which are commercially available and useful in accordance with the present invention are the products sold by GE Silicones under the trade designation SF96. Examples of polysiloxanes in the form of coploymers of polydimethylsiloxane and polyoxyalkylene ether which are commercially available and useful in accordance with the present invention are the products sold by GE Silicones under the trade designations SF1188A and SF1288. Examples of polysiloxane precursors in the form of a an amine curable, reactive polysiloxane which are commercially available and useful in accordance with the present invention are the products sold by GE Silicones under the trade designations SF1706.

The silicone coating or film forming agent may be contained in the present compositions in a wide variety of ranges, which may vary depending on several factors, such as the type and amount of other components in the composition and the intended end use of the film or coating. In certain preferred embodiments, however, the proportion of silicone coating or film forming agent, which preferably consists essentially of one or more polysiloxane compounds, one or more polysiloxane precursors, or a combination of polysiloxane(s) and polysiloxane precursor(s), is from about 0.005 wt % to about 25 wt % relative to the overall coating composition, more preferably from about 0.05 wt % to about 10 wt %, and even more preferably from about 0.05 wt % to about 5.0 wt %.

In certain preferred embodiments of the present invention, the carrier comprises a solvent-emulsifier which is an HFC corresponding to the general formula CₐH_{b}F_{c}O_{d} wherein a=2 to 10, b=1 to 21, c=1 to 21, d=0 to 4, provided that a, b and c are selected to provide a compound comprising from about 55 percent by weight to about 70 percent by weight of fluorine. Specific examples of preferred HFCs useful in practicing the present invention include, pentaflluoropropanes and pentafluorobutanes, with 1,1,1,3,3-pentaflluoropropane, 1,1,1,2,3,4,4,5,5,5-decaflluoropentane (HFC43-10 mee) being especially preferred. Hydrofluoroethanes, such as HFE 7100 and HFE 7200 are also preferred in certain embodiments.

The hydrofluorocarbon solvent-emulsifier of the present invention may be contained in the present compositions in a wide variety of ranges, which may vary depending on several factors, such as the type and amount of other components in the composition and the intended end use of the film or coating, provided that the amount is sufficient, in combination with the other components of the composition (such as the surfactant or other solvent if present) in an amount sufficient to emulsify or to solvate substantially all of said silicone coating agent. In certain preferred embodiments, however, the hydrofluorocarbon solvent-emulsifier of the present invention, which preferably consists essentially of one or more C₂-C₁₀ hydrofluorocarbon compounds in accordance with the fluorine content requirements as specified herein, comprises from about 50 percent by weight to about 99 percent by weight of the composition. In certain more preferred embodiments, the solvent-emulsifier comprises from about 50 percent by weight to about 95 percent by weight of the composition, and even more preferably about 50 percent by weight to about 90 percent by weight of the composition. In certain other more preferred embodiments, the solvent-emulsifier comprises from about 90 percent by weight to about 99 percent by weight of the composition, and even more preferably about 95 percent by weight to about 99 percent by weight of the composition.

In preferred embodiments the compositions contain a surfactant. The surfactant may be contained in the present compositions in a wide variety of ranges, which may vary depending on several factors, particularly the particular silicone and carrier being used. For compositions in which the silicone compound(s) are not fully dissolved in the carrier, the surfactant is preferably present in an amount sufficient, when combined with the carrier, to emulsify or disperse the soluble portion of the silicone coating agent which is not dissolved. In preferred embodiments, the compositions comprise surfactant in an amount of from about 0.1 wt % to about 5 wt % relative to the overall coating composition, more preferably from about 0.1 wt % to about 4 wt %, and even more preferably from about 0.1 wt % to about 2 wt %. A preferred surfactant is a siloxane coplymer with ethylene oxide. In preferred embodiments, the surfactant comprises a hydrocarbon chain with ethylene oxide units on one end. Also preferred are copolymers of ethyleneoxide and a hydrocarbon chain such as those available under the trade designation Novel II TDA 8 ethoxylate from Condea, Vistan.

Application of the composition of this invention to an article, device or any other substrate may be carried out by any conventional technique. For example, the composition may be brushed or sprayed (e.g., as an aerosol) onto the substrate, or the substrate may be immersed in the composition. After application of the composition, the carrier may be removed by evaporation. If desired, the rate of evaporation may be accelerated by application of reduced pressure or mild heat. The coating of the composition applied to the substrate may be of any convenient thickness, and in practice, the thickness will be determined by such factors as the viscosity of the silicone, the temperature of the application, and the desired end use. For most substrates, the coating composition is applied as thinly and as evenly as practical.

The preferred compositions can be used to coat the surfaces of a wide variety of devices and articles, including fabrics, paper, metal surfaces, glass, medical devices, needles of all sorts, electronic devices and parts, used as release agents for mechanical rubber, wire and cable goods, moldings of automotive floor mats, shock mounts, fan belts, food packaging and o-rings. The compositions can also be used to treat consumer goods such as soles and heels of footwear, and floor tiles.

### EXAMPLES

The following examples are intended to be illustrative of the present invention, but not limiting in any manner.

### Example 1

Eight (8) grams of HFC-245fa were mixed with 2.0 grams of hexane and 1.1 grams of SF1288 and allowed to stand at room temperature overnight. The result was one clear liquid phase. This example is repeated except isopropanol is used in place of hexane. The same result is produced.

### Example 2

Eight (8) grams of HFC-245fa were mixed with one (1)gram of SF96-3 silicone from GE-Silicones and one gram Novell II TDA-3 ethoxylate from Condea Vista and allowed to stand at room temperature over night. The result was one clear liquid phase with a surface tension of 18 dynes/cm at 10 C.

### Example 3

Eight (8) grams of HFC-245fa were mixed with one (1)gram of SF96-3 silicone from GE-Silicones and one gram Novell II TDA-8 ethoxylate from Condea Vista and allowed to stand at room temperature over night. The result was one clear liquid phase with a surface tension of 18.2 dynes/cm at 10 C.

### Example 4

Eight (8) grams of HFC-245fa were mixed with one (1)gram of SF1288 silicone from GE-Silicones and one gram Novell II TDA-8 ethoxylate from Condea Vista and allowed to stand at room temperature over night. The result was one clear liquid phase with a surface tension of 18.6 dynes/cm at 10 C.

### Example 5

Eight (8) grams of HFC-245fa were mixed with one (1)gram of SF1188a silicone from GE-Silicones and one gram Novell II TDA-8 ethoxylate from Condea Vista and allowed to stand at room temperature over night. The result was one clear liquid phase with a surface tension of 18.8 dynes/cm at 10 C.

### Example 6

Eight (8) grams of HFC-245fa were mixed with one (1)gram of SF93-3 silicone from GE-Silicones and one gram Novell II TDA-13.5 ethoxylate from Condea Vista and allowed to stand at room temperature over night. The result was one clear liquid phase with a surface tension of 18.3 dynes/cm at 10 C.

The above examples show that the present invention is capable of producing good solutions of silicones using HFC-245fa as the primary solvent/emulsifier, with either no VOC components or a minimum of VOC components.

### Example 7

Eight (8) grams of HFC-245fa were mixed with six (6) grams of hexane and 1.1 grams of SF96-1000 silicone from GE-Silicones and allowed to stand at room temperature over night. The result was one clear liquid phase.

It will be obvious to one skilled in the art that there are numerous modifications that can be made and additional ingredients that can be added to compositions of the present invention and still remain within the scope of the present invention.

What is claimed is:

1. A composition comprising:
a silicone coating agent comprising polysiloxane, a polysiloxane precursor, or combinations thereof;
a solvent-emulsifier comprising at least one C₂-C₁₀ fluorinated hydrocarbon compound containing not less than about 55 percent by weight and no more than about 76 percent by weight of fluorine, said at least one fluorinated hydrocarbon compound being present in the composition in an amount sufficient to emulsify or to solvate substantially all of said silicone coating agent.

2. The coating composition of claim 1 wherein said at least one fluorinated hydrocarbon comprises a hydrofluorocarbon.

3. The coating composition of claim 1 wherein said at least one fluorinated hydrocarbon comprises a C₂-C₆ hydrofluorocarbon.

4. The coating composition of claim 2 wherein said hydrofluorocarbon contains not less than about 55 percent by weight and no more than about 70 percent by weight of fluorine.

5. The coating composition of claim 1 wherein said at least one fluorinated hydrocarbon is selected from the group consisting of HFC-245fa, HFC-365mfc, HFE-7100, HFE-7200, and combinations of two or more thereof.

6. The coating composition of claim 1 wherein said solvent-emulsifier comprises from about 50 percent by weight to about 99 percent by weight of the composition.

7. The coating composition of claim 1 wherein said solvent-emulsifier comprises from about 90 percent by weight to about 99 percent by weight of the composition.

8. The coating composition of claim 1 wherein said solvent-emulsifier comprises from about 95 percent by weight to about 99 percent by weight of the composition.

9. The coating composition of claim 1 wherein said silicone coating agent comprises an organically modified polysiloxane.

10. The coating composition of claim 9 wherein said organically modified polysiloxane comprises a repeating unit described by the formula I 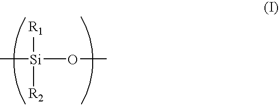
wherein R₁ and R₂ are the same or different, each independently representing an alkyl group, an aryl group, a group including a polyether unit, or a group including a polyester unit.

11. The coating composition of claim 10 wherein at least one of said R₁ and R₂ groups is an alkyl group having from about 1 to about 4 carbons.

12. The coating composition of claim 11 wherein said alkyl group is methyl, ethyl, or propyl.

13. The coating composition of claim 12 wherein said alkyl group is methyl.

14. The coating composition of claim 10 wherein R₁ and R₂ are both methyl.

15. The coating composition of claim 10 wherein said polysiloxane has a viscosity of from about 1 to about 1,000,000 centistokes at 25° C.

16. The coating composition of claim 13 wherein said polysiloxane has a viscosity of from about 5 to about 100,000 centistokes at 25° C.

17. The coating composition of claim 1 wherein said silicone agent comprises from about 0.005 weight percent to about 25 weight percent of the composition.

18. The coating composition of claim 1 wherein said silicone agent comprises from about 0.05 weight percent to about 10 weight percent of the composition.

19. The coating composition of claim 1 wherein said silicone agent comprises from about 0.05 weight percent to about 5 weight percent of the composition.

20. The coating composition of claim 1 further comprising a surfactant, said at least one fluorinated hydrocarbon compound and said surfactant together being present in the composition in amounts sufficient to emulsify or to solvate substantially all of said silicone coating agent.

21. The coating composition of claim 20 wherein said surfactant comprises an ethoxylate surfactant.

22. The coating composition of claim 1 further comprising one or more VOC components which in the aggregate comprise less than about 20% by weight of the composition.

23. A method of applying a silicone coating to a substrate comprising:
providing a composition comprising: (a) a silicone coating agent comprising polysiloxane, a polysiloxane precursor, or combinations thereof; and (b) a solvent-emulsifier comprising at least one C₂-C₁₀ fluorinated hydrocarbon compound containing not less than about 55 percent by weight and no more than about 75 percent by weight of fluorine, said at least one fluorinated hydrocarbon compound being present in the composition in an amount sufficient to emulsify or to solvate substantially all of said silicone coating agent; and
contacting a substrate to be coated with said provided composition.
